(19) United States
(12) Patent Application Publication
(10) Pub. No.: US 2026/0099790 A1
(43) Pub. Date: Apr. 9, 2026

(54) REAL-TIME CHANGE SUPPORT FOR CONDITIONAL SENTRIES IN CASE MANAGEMENT

(71) Applicant: SAP SE, Walldorf (DE)

(72) Inventors: Abhinav Kumar, Bangalore (IN); Vikas Rohatgi, Bangalore (IN)

(21) Appl. No.: 18/905,526

(22) Filed: Oct. 3, 2024

(51) Int. Cl. G06Q 10/0633; G06Q 10/0631

(52) U.S. Cl. CPC G06Q 10/0633; G06Q 10/06316

(57) ABSTRACT

In an example embodiment, a rule repository is stored within a rules framework separate and distinct from the Case Management Model and Notation (CMMN) framework. The rule repository contains rules for evaluating and producing results from conditions within CMMN sentries. A rules runtime can then be invoked by a sentry evaluator within the CMMN framework when a sentry is encountered during a CMMN flow. The rules runtime can then retrieve and execute the corresponding BPMN rule to perform dynamic evaluation of the conditions. This design allows for the conditions to be updated without the need to update the CMMN model.

### TECHNICAL FIELD

This document generally relates to computer systems. More specifically, this document relates to real-time change support for conditional sentries in case management.

### BACKGROUND

Case management involves managing various processes. In this context, the term “case” refers to a grouping of actions taken to perform some sort of desired outcome. It is often event-driven and utilized by organizations to manage processes involving processes with actions that need to be shared by multiple employees or members.

Case Management Model and Notation™ (CMMN™), created by the Object Management Group™ (OMG™) of Milford, MA, defines a common meta-model and notation for modeling and graphically expressing a case as well as an interchange format for exchanging case models among different tools. CMMN is intended to capture the common elements that case management products use, while also taking into account current research contributions on case management. Known as an Adaptive Case Management, CMMN aids in the decision-making process through suggestions. CMMN is centered around information and relationships, in contrast to more traditional process management centered around a priori defined activity sequences.

### BRIEF DESCRIPTION OF DRAWINGS

The present disclosure is illustrated by way of example and not limitation in the figures of the accompanying drawings, in which like references indicate similar elements.

FIG. 1 is a diagram illustrating an example CMMN used to represent a case for processing insurance claims, in accordance with an example embodiment.

FIG. 2 is a block diagram illustrating a system for handling a software case runtime, in accordance with an example embodiment.

FIG. 3 is a block diagram illustrating a system for handling a software case runtime, in accordance with another example embodiment.

FIG. 4 is a diagram illustrating a screen capture of part of a screen of a case authoring UI 204 in accordance with an example embodiment.

FIG. 5 is a diagram illustrating a screen capture of a screen of a rule authoring UI in accordance with an example embodiment.

FIG. 6 is a flow diagram illustrating a method, in accordance with an example embodiment.

FIG. 7 is a block diagram illustrating an architecture of software, which can be installed on any one or more of the devices described herein.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description herein discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

The event-driven nature of CMMN allows for modelling processes triggered by specific events, making it ideal for scenarios with dynamic elements like customer inquiries or regulatory changes. In unstructured processes, often encountered in healthcare, legal, and customer service, CMMN provides a flexible framework for capturing the inherent variability.

One notable feature contributing to CMMN's adaptability is the use of sentries. Sentries are conditions associated with plan items in the case, determining when they should be activated or completed. For instance, a task may only proceed when specific conditions are met, offering a dynamic control mechanism based on the evolving state of the case. This capability enhances the precision and responsiveness of case management, ensuring that the case aligns seamlessly with the evolving requirements. In essence, CMMN's event-driven approach, support for unstructured processes, and the strategic use of sentries make it a robust solution for modelling and managing dynamic cases in diverse business environments.

CMMN Sentries, at their core, are pivotal components of CMMN, enabling the modelling of intricate conditions for triggering or terminating elements within a case. Among them, conditional sentries stand out as powerful tools for defining nuanced criteria that dynamically influence the progression of a case.

Conditional sentries in CMMN go beyond conventional event-based triggers by providing a sophisticated mechanism for evaluating conditions at runtime. These conditions often involve variables, expressions, or external factors, allowing for a more granular and adaptive approach to case management.

Key Features of Conditional sentries are:
1. Dynamic Condition Evaluation: Conditional sentries excel in their ability to assess conditions dynamically during the execution of a case, enabling real-time adaptation and responsiveness.
2. Expression Language Sophistication: CMMN's support for expressive languages, such as the Unified Expression Language (UEL), provides a standardized means to craft intricate conditions. This opens the door to modelling complex business logic with precision.

Despite the various benefits of conditional sentries, the current setup to model conditional sentries poses a formidable challenge that arises from the inherent tight coupling of conditional sentries with the definition of the core process in case implementations. This tight integration brings forth a cascade of technical issues, such as:
1. Redeployment Overhead Amplified: The need for a complete redeployment of the entire core case, whenever a change in conditions is required, amplifies the operational overhead. In large-scale organizations with intricate case structures and various guidelines to deploy a newer version, this becomes a significant operational bottleneck.
2. Clean Core Principle Under Siege: The tight integration of conditional sentries undermines the clean core principle, which involves standardized guidelines for all elements of the core, challenging the separation of business logic and core processes.
3. Freedom of Updating Hindered: The dependency on Information Technology (IT) for even minor adjustments to conditions hinders the empowerment of business users. Instead of fostering agility, organizations find themselves mired in bureaucratic processes, counteracting the original vision of a flexible and user-friendly case management system.

In an example embodiment, sentries in CMMN are implemented by calling separate rules (e.g., Business Process Model and Notation (BPMN) rules). CMMN and BPMN represent two distinct paradigms in the domain of process modeling. CMMN, grounded in a declarative approach, excels in managing intricate and unstructured business cases, emphasizing flexibility through the definition of outcomes without prescribing granular steps. In contrast, BPMN is designed for well-defined, stable, and repeatable processes.

More particularly, a rule repository is stored within a rule framework separate and distinct from the CMMN framework. The rule repository contains rules for evaluating and producing results from conditions within CMMN sentries. A rules runtime can then be invoked by a sentry evaluator within the CMMN framework when a sentry is encountered during a CMMN flow. The rules runtime can then retrieve and execute the corresponding rule to perform dynamic evaluation of the conditions. This design allows for the conditions to be updated without the need to update the CMMN model.

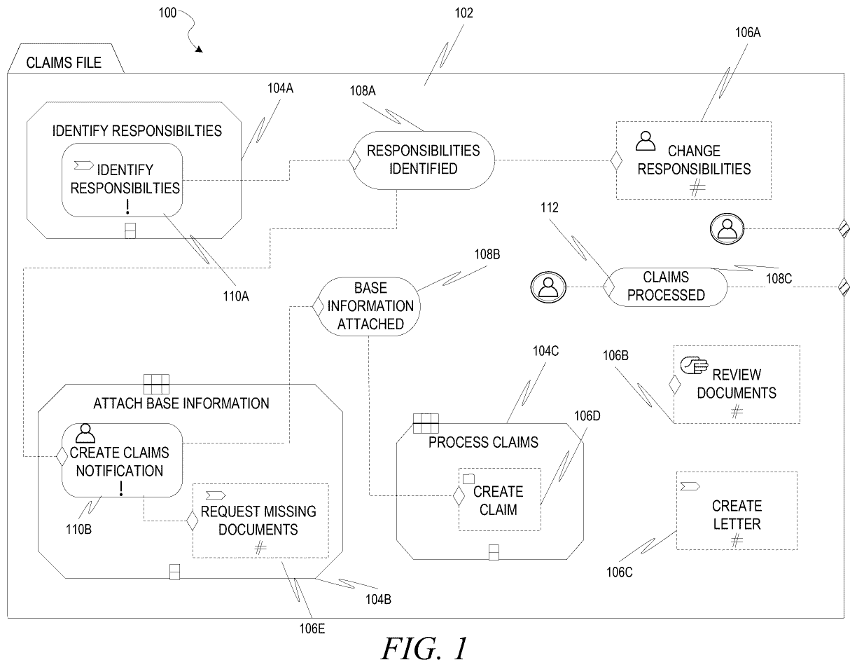

FIG. 1 is a diagram illustrating an example CMMN 100 used to represent a case for processing insurance claims, in accordance with an example embodiment. The CMMN 100 contains a number of different elements, including a case plan model 102 (in the shape of a folder), which serves as a top-level container for defining the case structure and organizing its elements, stages 104A, 104B and 104C (in an octagonal shape), which represent major phases within a case (and can be mandatory or discretionary), and can be used to group and organize tasks and events related to specific phases of the case, tasks 106A, 106B, 106C, 106D, 106E (in the shape of a rectangle) represent individual work items or activities that need to be performed as part of the case (they can be mandatory [symbolized with a !], repeatable [symbolized with a #], or discretionary [symbolized by a dashed rectangle]), and milestones 108A, 108B, 108C (in the shape of a oval), represent occurrences or achievements of a milestone that can be used to indicate the initiation or completion of tasks or other changes. There are also tasks 110A, 110B (in the shape of a rounded rectangle), within the case, and sentries (such as 112, in the shape of diamonds), which are used to represent dynamic conditions or events that act as a criterion to activate a task. Additionally, task 106A has an icon representing a person, indicating that this is a human task. Likewise, task 106B has an icon representing a hand, indicating that this is a non-blocking human task.

The initial phase of the methodology is data collection, encompassing real-time data acquisition from the running CMMN process. This dynamic and comprehensive dataset not only includes runtime logs but also critical input/output context for each individual activity or step.

Runtime logs are used as they construct a flow graph that meticulously traces the specific paths taken by various process instances. They offer insights into process dynamics, revealing dependencies between various tasks at runtime, enabling a real-time understanding of the relationships between activities.

Importantly, these logs provide valuable information about the sequence of actions taken by knowledge workers, shedding light on the decision-making processes within the CMMN framework.

Simultaneously, real-time context information (e.g., input/output context for each individual activity or step) can be leveraged, extending beyond resource utilization to capture the specific actions taken by knowledge workers in real-time. This context encapsulates the interplay of context and decision-making. It delves into the intricacies of decision-making, resource allocation, and adaptive behavior within the CMMN framework, revealing the profound impact of context on the knowledge worker's actions.

The collected data undergoes rigorous pre-processing, ensuring its quality and consistency. Data cleaning procedures systematically eliminate errors and inaccuracies, guaranteeing the reliability and accuracy of the dataset. Data normalization is then applied to standardize units of measurement, making it possible to compare and analyze different data elements effectively.

In essence, the data collection phase captures real-time insights that illuminate the interplay of context and decision-making within the CMMN process. This rich dataset is the basis upon which the subsequent stages of analysis and optimization are built, delivering a comprehensive understanding of knowledge worker actions and their impact on the process.

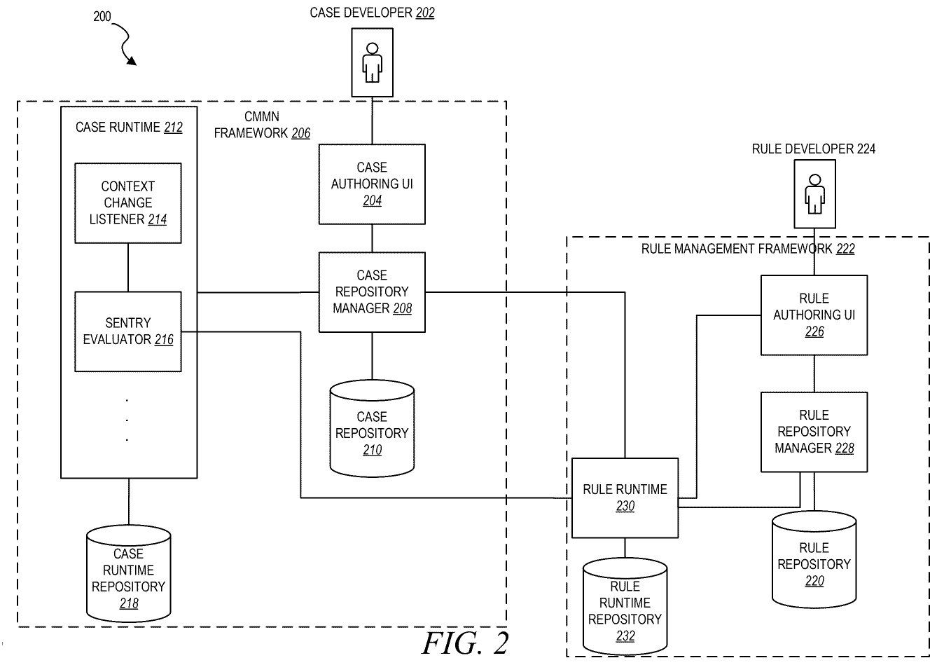

FIG. 2 is a block diagram illustrating a system 200 for handling a software case runtime, in accordance with an example embodiment. More particularly, a case developer 202 uses a case authorizing user interface (UI) 204 within a CMMN framework 206 to create a case model containing CMMN elements. The CMMN elements comprise at least one sentry object. A case repository manager 208 then stores the case model in a case repository 210.

When the case is run, a case runtime 212 is launched. In the case runtime 212, a context change listener 214 listens for contextual changes while the case model is running. On every context change, a sentry evaluator 216 evaluates the sentry to see if anything got activated or deactivated. This may include evaluating whatever conditions are contained within the sentry object corresponding to the sentry. A case runtime repository 218, is used at design time. In an example embodiment, either in lieu of or in addition to conditions in the sentry object itself, the sentry object also includes a reference to one or more rules containing conditions to be evaluated. These one or more Rules may be stored in a rule repository 220 of a Rules framework 222.

More particularly, a rule developer 224 may author the one or more rules using a rule authoring UI 226, which a rule repository manager 228 may store in the rule repository 220. It should be noted that while in many cases the case developer 202 is a different person than the rule developer 224, this is not mandatory and in some scenarios, they will be the same person.

Therefore, at runtime, the sentry evaluator 216 may, when it encounters such a sentry, call a rule runtime 230 within the rules framework. The rules runtime obtains the corresponding rule(s) from the rule repository and evaluates the corresponding condition(s) in the corresponding rule(s) using a rule runtime repository 232, on a deploy action. Results from this evaluation process can then be sent as results to the sentry evaluator 216, which may cause the case runtime 212 to then proceed with the rest of the case model execution as if the condition(s) were evaluated by the case runtime 212 itself.

It should be noted that the rule runtime 230 can either retrieve the corresponding rule(s) from the rule repository 220 at runtime, or may preload one or more rules from the rule repository 220 prior to the case runtime 212 beginning execution of the case model.

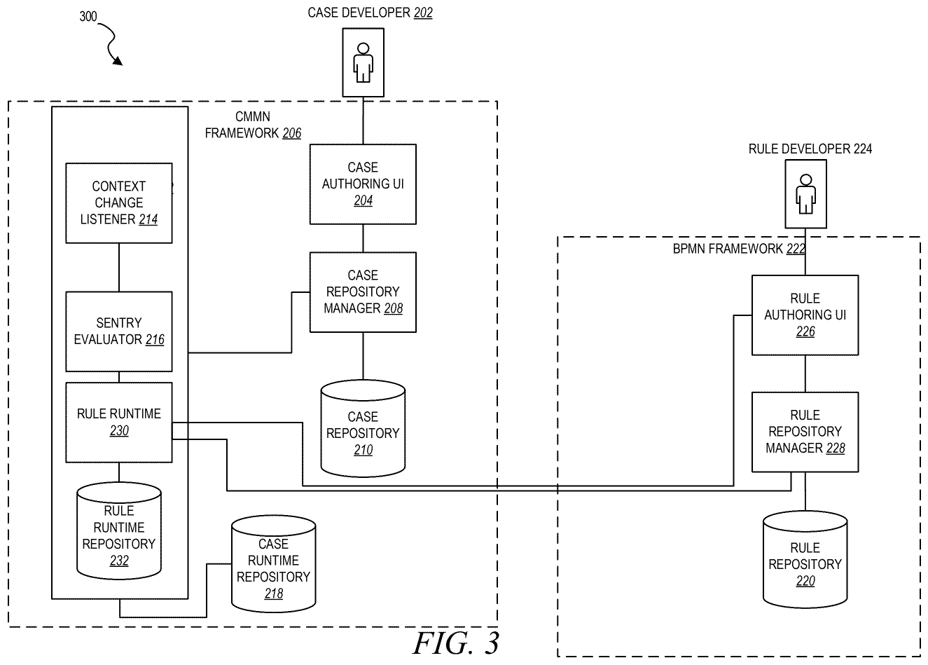

FIG. 3 is a block diagram illustrating a system 300 for handling a software case runtime, in accordance with another example embodiment. The system 300 is similar to the system 200 of FIG. 2, except that the rule runtime 230 and rule runtime repository 232 are contained within the case runtime 212. This embodiment allows for quicker execution of the rules and separation of the execution of the rules in the rule runtime 230 from the rules framework 222, which may be useful in faster evaluation of conditions as the rule evaluation happens in the same process without involving two systems or processes. Nevertheless, the system 200 of FIG. 2 does result in a separation of the rule runtime 230 from the CMMN framework 206, which may be useful in load balancing the CMMN framework 206. Which architecture is preferred will largely be determined based on the intricacies of the computing environment and performance requirements on which it is implemented.

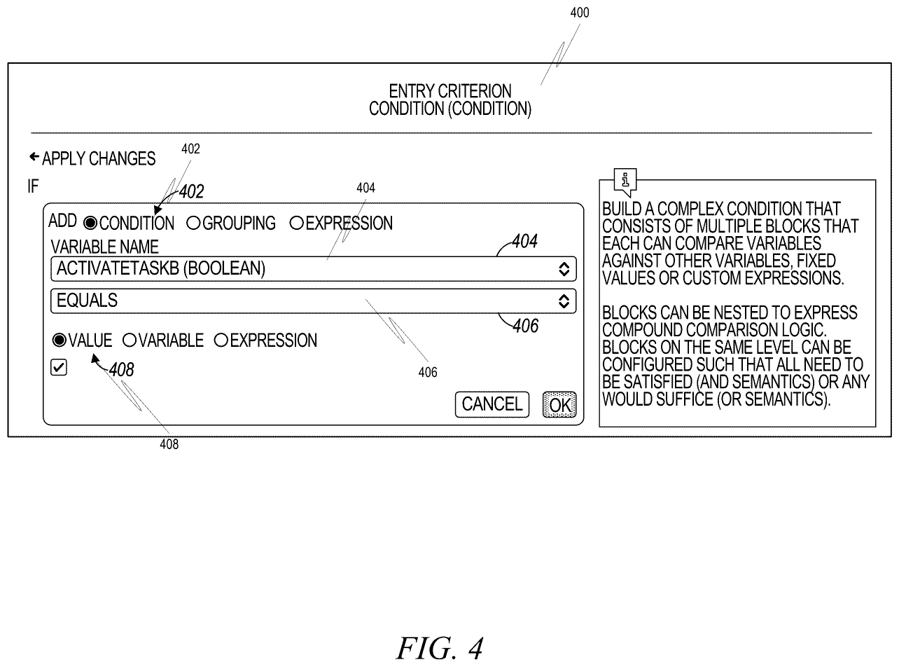

FIG. 4 is a diagram illustrating a screen capture of part of a screen 400 of a case authoring UI 204 in accordance with an example embodiment. Here, the screen 400 is a screen where a user would ordinarily add a condition to a sentry. Specifically, the screen 400 includes a portion 402 where a user is able to select that a condition is being supplied, a first drop-down menu 404, where a user can indicate a variable from the case model to evaluate along and a second drop-down menu 406, where a user can indicate an operator (e.g., equals, greater than, less than, etc.) for the condition. Lastly, a portion 408 is provided where the user can indicate what the variable is being evaluated against, such as a value, variable, or expression, and to provide such a value, variable, or expression.

Once the condition is entered, the user is able to then use the case authoring UI 204 of FIG. 2 to deploy the sentry, but as mentioned earlier this deployment necessitates updating and deploying the case model each time there is a change to the sentry condition(s).

As such, in an example embodiment, the condition(s) is instead provided via the rule authoring UI 226 of the rules framework 222 rather than the case authoring UI 204 in the CMMN framework 206.

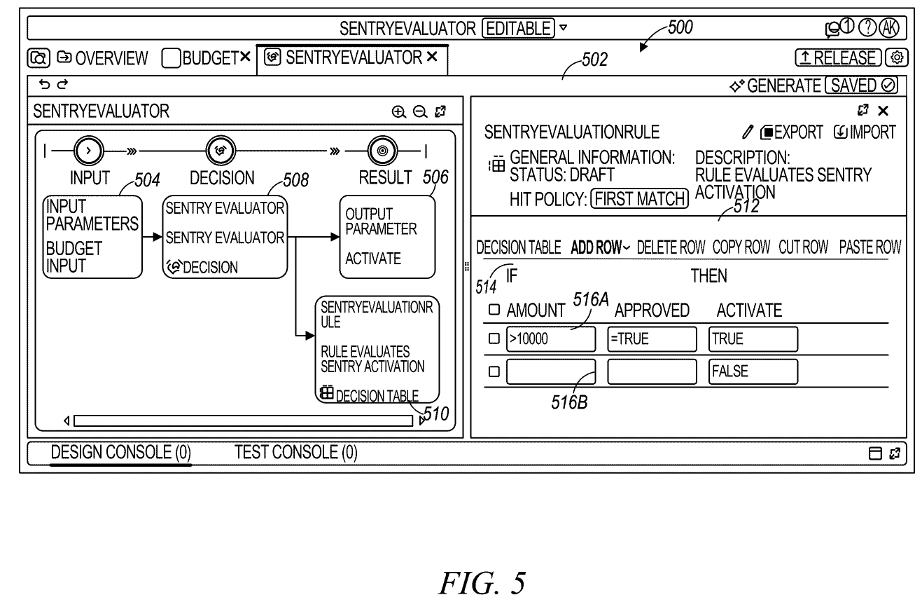

FIG. 5 is a diagram illustrating a screen capture of a screen 500 of a rule authoring UI 226 in accordance with an example embodiment. Here, the screen 500 includes a portion 502 where a user can graphically view a decision diagram for a rule, specifying input parameters 504, output parameters 506, decisions 508, and rules 510. Portion 512 is where selected nodes from portion 502 may be added or modified. Here, for example, the rule 510 is being edited, and portion 512 depicts a decision table 514, which captures input, output, and a set of rules (decision table/text rule). Decision is the artifact that gets invoked (which itself invokes all the rules in it). The decision is like an interface that helps a user understand what they need to pass as input and what output they will receive. A decision may comprise many rules and it is not always necessary that each rule will be based on an input parameter as it can be intermediate rule working on outputs of previous rules.

Each row 516A, 516B of the decision table 514 establishes a different condition and result of the condition. Thus, row 516A here establishes the condition “If amount>10000 then it is approved and activate a true response. Row 516B essentially captures all other scenarios (e.g., the amount is <=10000, and thus a false response is activated

While not pictured, the rule authorizing UI 226 of FIG. 2 can also include a versioning functionality. Here, when a rule changes, a version associated with that rule can also be changed (typically increased). This allows rule versions to run independently from case model versions. In an example embodiment, newer rule versions are referenced by newer case model versions, eliminating the need to perform any sort of check to determine whether the newer rule version is compatible with an older case model version. The versioning functionality also allows for auditing of the system, such that changes to critical rules can be monitored and rolled back if necessary. This version can either be manual or can be automatic, where a new version is created for every release of an amended rule set.

Referring back to FIGS. 2 and 3, in an example embodiment, rather than the case developer 202 specifying one or more rules from the rule repository 220 that contain one or more conditions the case developer 202 is trying to link to the sentry object, a machine learning model is utilized to suggest one or more appropriate rules for the case developer 202 to select from. This recommendation machine learning model may be trained by any model from among many different potential supervised or unsupervised machine learning algorithms. It can also comprise multiple models working in tandem to achieve the goal. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the machine learning algorithm used to train the machine learning model may iterate among various weights (which are the parameters) that will be multiplied by input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the machine learning model may take place as a dedicated training phase. In other example embodiments, the machine learning model may be retrained dynamically at runtime by the user providing live feedback.

Input to the machine learning model can include the context of the case authoring UI 204 at the time the recommendation is going to be made. This context can include, for example, an indication of the sentry object the case developer 202 is attempting to add or modify and the CMMN case model itself. The machine learning model may be trained using training data that comprises past contexts and specified rules for sentries in those contexts. For example, any instances where a case developer 202 specified a particular rule for a particular sentry can be considered as a positive training sample for that rule to be recommended for similar sentries in the future.

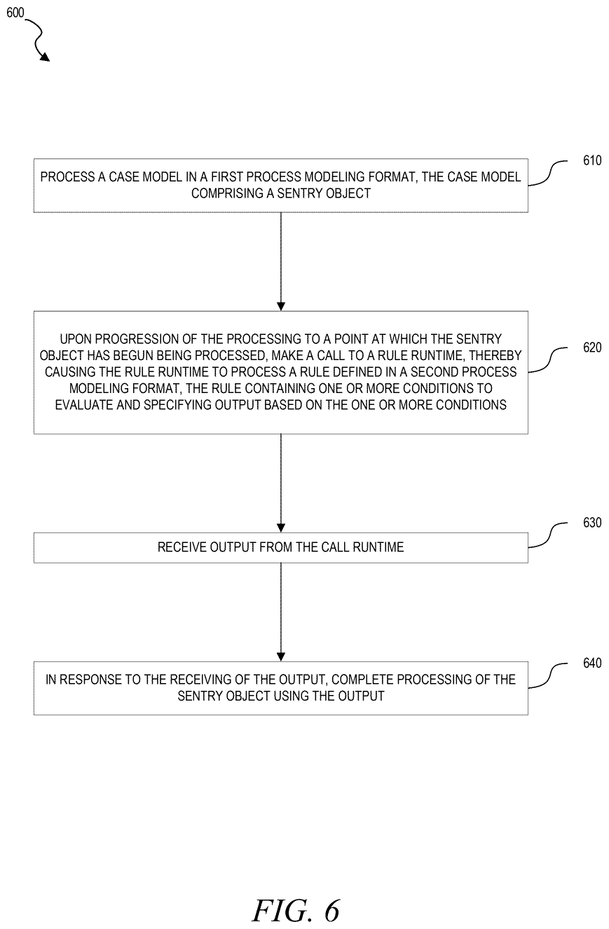

FIG. 6 is a flow diagram illustrating a method 600, in accordance with an example embodiment.

At operation 610, a case model in a first modeling format is processed. The case model has a sentry object.

At operation 620, upon sentry reevaluation (such as when there is a change in context), a call is made to a rule runtime, thereby causing the rule runtime to process a rule defined in a second modeling format, the rule containing one or more conditions to evaluate and specifying output based on the one or more conditions. In an example embodiment, the second modeling format is the Decision Model and Notation (DMN) format.

At operation 630, output is received from the call runtime.

At operation 640, in response to the receiving of the output, processing of the sentry object is completed using the output.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: processing a case model in a first modeling format, the case model comprising a sentry object; upon evaluation of the sentry object, making a call to a rule runtime, thereby causing the rule runtime to process a rule defined in a rule modeling format, the rule containing one or more conditions to evaluate, and specifying an output based on the one or more conditions; receiving the output from the call runtime; and in response to the receiving of the output, completing processing of the sentry object using the output.

In Example 2, the subject matter of Example 1 includes, wherein the operations are performed within a decision modeling format framework and wherein the call runtime is located within a rule modeling format framework separate and distinct from the decision modeling format framework.

In Example 3, the subject matter of Examples 1-2 includes, wherein the operations are performed within a decision modeling format framework and wherein the call runtime is located within the decision modeling format framework but the call runtime obtains the rule from a rule repository stored in a rule modeling format framework separate and distinct from the decision modeling format framework.

In Example 4, the subject matter of Examples 1-3 includes, wherein the rule is created using a first user interface separate and distinct from a second user interface used to create the case model.

In Example 5, the subject matter of Example 4 includes, wherein the first user interface includes a versioning functionality allowing a user to specify a version number for the rule.

In Example 6, the subject matter of Examples 4-5 includes, wherein the second user interface provides a list of one or more automatic recommendations of rules when the second user interface is used to create a process with the sentry object.

In Example 7, the subject matter of Example 6 includes, wherein the one or more automatic recommendations of rules are produced by a machine learning model based on the case model and contextual information from the second user interface.

Example 8 is a method comprising: processing a case model in a first modeling format, the case model comprising a sentry object; upon evaluation of the sentry object, making a call to a rule runtime, thereby causing the rule runtime to process a rule defined in a rule modeling format, the rule containing one or more conditions to evaluate, and specifying an output based on the one or more conditions; receiving the output from the call runtime; and in response to the receiving of the output, completing processing of the sentry object using the output.

In Example 9, the subject matter of Example 8 includes, wherein the method is performed within a decision modeling format framework and wherein the call runtime is located within a rule modeling format framework separate and distinct from the decision modeling format framework.

In Example 10, the subject matter of Examples 8-9 includes, wherein the method is performed within a decision modeling format framework and wherein the call runtime is located within the decision modeling format framework but the call runtime obtains the rule from a rule repository stored in a rule modeling format framework separate and distinct from the decision modeling format framework.

In Example 11, the subject matter of Examples 8-10 includes, wherein the rule is created using a first user interface separate and distinct from a second user interface used to create the case model.

In Example 12, the subject matter of Example 11 includes, wherein the first user interface includes a versioning functionality allowing a user to specify a version number for the rule.

In Example 13, the subject matter of Examples 11-12 includes, wherein the second user interface provides a list of one or more automatic recommendations of rules when the second user interface is used to create a process containing the sentry object.

In Example 14, the subject matter of Example 13 includes, wherein the one or more automatic recommendations of rules are produced by a machine learning model based on the case model and contextual information from the second user interface.

Example 15 is a non-transitory machine-readable medium storing instructions which, when executed by one or more processors, cause the one or more processors to perform operations comprising: processing a case model in a first modeling format, the case model comprising a sentry object; upon evaluation of the sentry object, making a call to a rule runtime, thereby causing the rule runtime to process a rule defined in a rule modeling format, the rule containing one or more conditions to evaluate, and specifying an output based on the one or more conditions; receiving the output from the call runtime; and in response to the receiving of the output, completing processing of the sentry object using the output.

In Example 16, the subject matter of Example 15 includes, wherein the operations are performed within a decision modeling format framework and wherein the call runtime is located within a rule modeling format framework separate and distinct from the decision modeling format framework.

In Example 17, the subject matter of Examples 15-16 includes, wherein the operations are performed within a decision modeling format framework and wherein the call runtime is located within the decision modeling format framework but the call runtime obtains the rule from a rule repository stored in a rule modeling format framework separate and distinct from the decision modeling format framework.

In Example 18, the subject matter of Examples 15-17 includes, wherein the rule is created using a first user interface separate and distinct from a second user interface used to create the case model.

In Example 19, the subject matter of Example 18 includes, wherein the first user interface includes a versioning functionality allowing a user to specify a version number for the rule.

In Example 20, the subject matter of Examples 18-19 includes, wherein the second user interface provides a list of one or more automatic recommendations of rules when the second user interface is used to create a process containing the sentry object.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

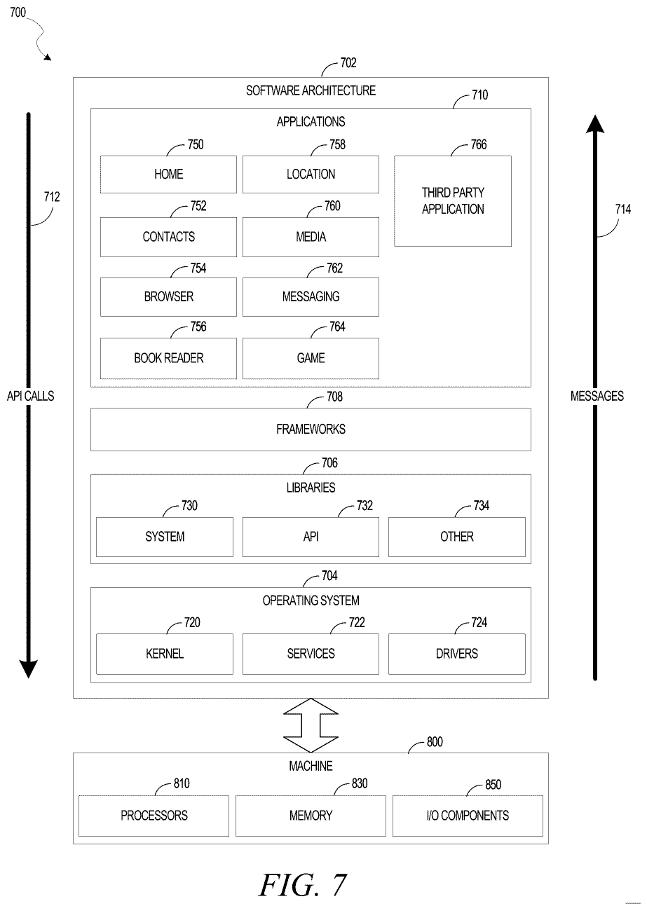

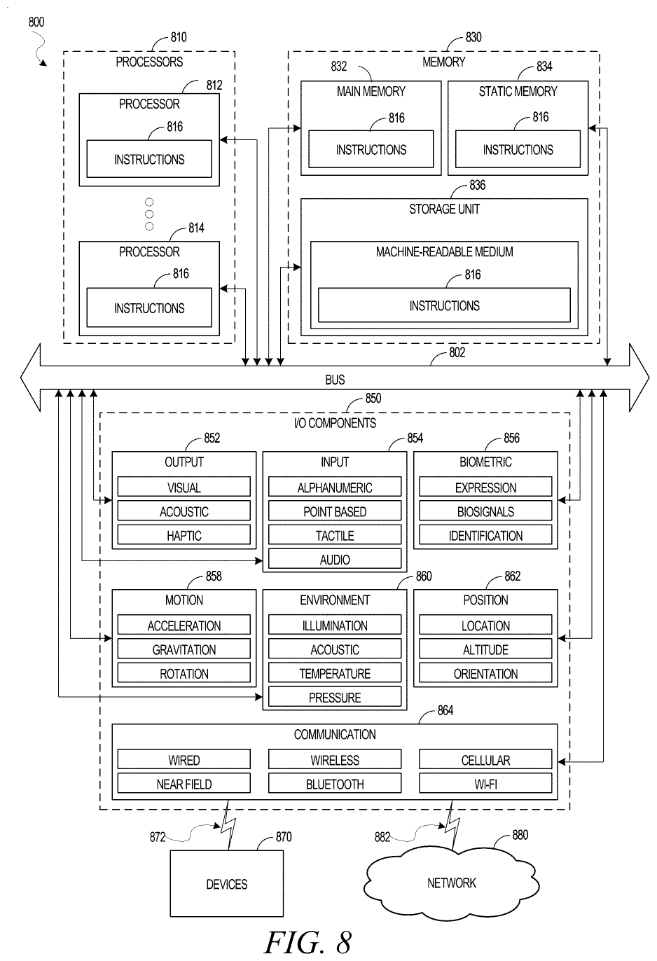

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that comprises processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionalities. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [JPEG or JPG], or Portable Network Graphics [PNG]), graphics libraries (e.g., an OpenGL framework used to render in two dimensions [2D] and three dimensions [3D] in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various GUI functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit [SDK] by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the method 600 of FIG. 6. Additionally, or alternatively, the instructions 816 may implement FIGS. 1-6 and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor 812), multiple processors 812, 814 with a single core, multiple processors 812, 814 with multiple cores, or any combination thereof.

The memory 830 may include a main memory 832, a static memory 834, and a storage unit 836, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel [PDP], a light-emitting diode [LED] display, a liquid crystal display [LCD], a projector, or a cathode ray tube [CRT]), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., coupled via a USB).

Moreover, the communication components 864 may detect identifiers or include components operable to detect identifiers. For example, the communication components 864 may include radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

The various memories (e.g., 830, 832, 834, and/or memory of the processor[s] 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
processing a case model in a first modeling format, the case model comprising a sentry object;
upon evaluation of the sentry object, making a call to a rule runtime, thereby causing the rule runtime to process a rule defined in a rule modeling format, the rule containing one or more conditions to evaluate, and specifying an output based on the one or more conditions;
receiving the output from the call runtime; and
in response to the receiving of the output, completing processing of the sentry object using the output.

2. The system of claim 1, wherein the operations are performed within a decision modeling format framework and wherein the call runtime is located within a rule modeling format framework separate and distinct from the decision modeling format framework.

3. The system of claim 1, wherein the operations are performed within a decision modeling format framework and wherein the call runtime is located within the decision modeling format framework but the call runtime obtains the rule from a rule repository stored in a rule modeling format framework separate and distinct from the decision modeling format framework.

4. The system of claim 1, wherein the rule is created using a first user interface separate and distinct from a second user interface used to create the case model.

5. The system of claim 4, wherein the first user interface includes a versioning functionality allowing a user to specify a version number for the rule.

6. The system of claim 4, wherein the second user interface provides a list of one or more automatic recommendations of rules when the second user interface is used to create a process with the sentry object.

7. The system of claim 6, wherein the one or more automatic recommendations of rules are produced by a machine learning model based on the case model and contextual information from the second user interface.

8. A method comprising:
processing a case model in a first modeling format, the case model comprising a sentry object;
upon evaluation of the sentry object, making a call to a rule runtime, thereby causing the rule runtime to process a rule defined in a rule modeling format, the rule containing one or more conditions to evaluate, and specifying an output based on the one or more conditions;
receiving the output from the call runtime; and
in response to the receiving of the output, completing processing of the sentry object using the output.

9. The method of claim 8, wherein the method is performed within a decision modeling format framework and wherein the call runtime is located within a rule modeling format framework separate and distinct from the decision modeling format framework.

10. The method of claim 8, wherein the method is performed within a decision modeling format framework and wherein the call runtime is located within the decision modeling format framework but the call runtime obtains the rule from a rule repository stored in a rule modeling format framework separate and distinct from the decision modeling format framework.

11. The method of claim 8, wherein the rule is created using a first user interface separate and distinct from a second user interface used to create the case model.

12. The method of claim 11, wherein the first user interface includes a versioning functionality allowing a user to specify a version number for the rule.

13. The method of claim 11, wherein the second user interface provides a list of one or more automatic recommendations of rules when the second user interface is used to create a process containing the sentry object.

14. The method of claim 13, wherein the one or more automatic recommendations of rules are produced by a machine learning model based on the case model and contextual information from the second user interface.

15. A non-transitory machine-readable medium storing instructions which, when executed by one or more processors, cause the one or more processors to perform operations comprising:
processing a case model in a first modeling format, the case model comprising a sentry object;
upon evaluation of the sentry object, making a call to a rule runtime, thereby causing the rule runtime to process a rule defined in a rule modeling format, the rule containing one or more conditions to evaluate, and specifying an output based on the one or more conditions;
receiving the output from the call runtime; and
in response to the receiving of the output, completing processing of the sentry object using the output.

16. The non-transitory machine-readable medium of claim 15, wherein the operations are performed within a decision modeling format framework and wherein the call runtime is located within a rule modeling format framework separate and distinct from the decision modeling format framework.

17. The non-transitory machine-readable medium of claim 15, wherein the operations are performed within a decision modeling format framework and wherein the call runtime is located within the decision modeling format framework but the call runtime obtains the rule from a rule repository stored in a rule modeling format framework separate and distinct from the decision modeling format framework.

18. The non-transitory machine-readable medium of claim 15, wherein the rule is created using a first user interface separate and distinct from a second user interface used to create the case model.

19. The non-transitory machine-readable medium of claim 18, wherein the first user interface includes a versioning functionality allowing a user to specify a version number for the rule.

20. The non-transitory machine-readable medium of claim 18, wherein the second user interface provides a list of one or more automatic recommendations of rules when the second user interface is used to create a process containing the sentry object.
